(19) United States
(12) Patent Application Publication
(10) Pub. No.: US 2026/0150146 A1
(43) Pub. Date: May 28, 2026

(54) METHOD, DEVICE, AND MEDIUM FOR REESTABLISHMENT CONNECTIVITY SERVICE

(71) Applicant: Verizon Patent and Licensing Inc., Basking Ridge, NJ (US)

(72) Inventors: Arvind Kumar, Suwanee, GA (US); Sachin Vargantwar, Cumming, GA (US); Robert Walley, Canton, GA (US)

(21) Appl. No.: 18/962,776

(22) Filed: Nov. 27, 2024

(51) Int. Cl. H04W 76/19; H04W 24/04

(52) U.S. Cl. CPC H04W 76/19; H04W 24/04

(57) ABSTRACT

A method, a network device, and a non-transitory computer-readable storage medium are described in relation to a reestablishment connectivity service. The reestablishment connectivity service may include generating and providing minimum receive level cell information used only for reestablishment by end devices. The minimum receive level cell information may include a minimum receive level value, such as a qRXLevMin value associated with a cell selection criterion. The minimum receive level cell information may include correlated data, such as a Fifth Generation Quality of Service Identifier (5QI) value, an application service identifier, a category of an application service, or a traffic characteristic value. The minimum receive level value may differ from a minimum receive level value for non-reestablishment by end devices.

### BACKGROUND

Development and design of networks present certain challenges from a network-side perspective and an end device perspective. For example, the establishment and maintenance of end device connectivity in a radio network environment present technical challenges.

### BRIEF DESCRIPTION OF THE DRAWINGS

FIG. 1 is a diagram illustrating an exemplary environment in which an exemplary embodiment of a reestablishment connectivity service may be implemented;

FIG. 2A is a diagram illustrating another exemplary environment in which an exemplary embodiment of the reestablishment connectivity service may be implemented according to an exemplary scenario;

FIG. 2B is a diagram illustrating exemplary functional components of a device configured to provide an exemplary embodiment of the reestablishment connectivity service;

FIGS. 2C and 2D are diagrams illustrating an exemplary process of an exemplary embodiment of the reestablishment connectivity service;

FIG. 3 is a diagram illustrating exemplary components of a device that may correspond to one or more of the devices illustrated and described herein; and

FIG. 4 is a flow diagram illustrating an exemplary process of an exemplary embodiment of the reestablishment connectivity service.

### DETAILED DESCRIPTION

The following detailed description refers to the accompanying drawings. The same reference numbers in different drawings may identify the same or similar elements. Also, the following detailed description does not limit the invention.

Measurement reports can be triggered at an end device (e.g., user equipment (UE)) based on reference signal received power (RSRP) values and reference signal received quality (RSRQ) values relative to certain events. For example, events may be defined by a standards body, such as Third Generation Partnership Project (3GPP), 3GPP2, International Telecommunication Union (ITU), European Telecommunications Standards Institute (ETSI), GSM Association (GSMA), and the like, such as “A type” of events, “B type” of events, and so forth. For example, an event A1 indicates that the serving cell becomes better than a threshold. According to at least some network standards, cell selection criterion abides by a cell selection criterion S in which the cell selection criterion S is fulfilled when:

$$Srxlev > 0 and Squal > 0 , \qquad ( 1 )$$

$$where :$$

$$Srxlev = {Q}_{rxlevmeas} - ( {Q}_{rxlevmin} + {Q}_{rxlevminoffset} ) - {P}_{compensation} - {Qoffset}_{temp} \qquad ( 2 )$$

$$Squal = {Q}_{qualmeas} - ( {Q}_{qualmin} + {Q}_{qualminoffset} ) - {Qoffset}_{temp} \qquad ( 3 )$$

The parameter Qᵣₓₗₑᵥₘᵢₙ indicates a minimum required receive (RX) level in the cell (e.g., in dBm). The end device may obtain or calculate (e.g., based on an offset value) a value for Qᵣₓₗₑᵥₘᵢₙ based on receiving a control plane message, such as a System Information Block (SIB) message. For example, the SIB message may be implemented as a SIB 1, SIB 2, or another type of SIB message (e.g., SIB 4, etc.). By way of further example, when the end device searches for a network as a part of network acquisition, the end device may obtain a value for a q-RxLevMin parameter from a SIB message, and if the serving cell strength satisfies the q-RxLevMin value, the end device may connect with an access device, such as a next generation Node B (gNB) or another type of radio access network (RAN) device. According to other exemplary implementations, different criteria and/or equations other than equations (1), (2), and/or (3) may be used for cell selection or reselection by the end device.

In the event that the radio connection drops, is lost, temporarily disrupted, or part of a handover to a new cell, the end device will attempt to reconnect to the wireless network in accordance with a reestablishment procedure (e.g., a Radio Resource Control (RRC) Connection Reestablishment procedure, etc.). Typically, the end device will execute the reestablishment procedure using the same q-RxLevMin value. Unfortunately, this framework may inhibit the end device from successfully finding a cell that satisfies the q-RxLevMin value due to its value. For example, in a radio connection drop environment, the q-RXLevMin value may be too high a value. As a consequence, the end device or user may experience prolonged interruptions in radio connectivity, inability to access and use an application service, loss of network presence of the end device, and so forth. Currently, there is no option to set a q-RxLevMin value or a similar value specifically and differently for reestablishment compared to non-reestablishment.

According to an exemplary embodiment, the reestablishment connectivity service may include providing a minimum receive level value exclusive to radio reestablishment. According to various exemplary embodiments, the reestablishment connectivity service may be provided in a legacy, current, or future generation wireless environments and radio access technologies (RATs), such as Fourth Generation (4G), Fifth Generation (5G), 5G-Advanced, Sixth Generation (6G), Seventh Generation (7G), and so forth.

According to an exemplary embodiment, the minimum receive level value may be implemented as a q-RxLevMin value. According to another exemplary embodiment, the minimum receive level value may be implemented as a q-RxLevMinSUL value. According to yet another exemplary embodiment, the minimum receive level value may include the q-RxLevMin value or the q-RxLevMinSUL value in combination with an offset value, as described herein.

According to an exemplary embodiment, the minimum receive level value may be application service (e.g., an individual application), category of an application service, Quality of Service (QOS), and/or traffic specific. For example, the minimum receive level value may correlate to a particular 5G QoS Identifier (5QI) value, an application service identifier, an application service category identifier (e.g., extreme real-time, streaming, IoT, over-the-top (OTT), etc.), and/or a traffic characteristic identifier or value (e.g., bursty traffic, continuous traffic, periodic, a periodic, one or multiple performance metric values relating to throughput, latency, or other types of service level agreement (SLA)/QoS parameters/values, etc.) associated with the application service of relevance. By way of further example, an end device participating in an application service session (e.g., a Voice over New Radio (VoNR) call or another type of application service session), and the radio access bearer is lost during the session, the end device may attempt to re-establish the radio connection with the minimum receive level value and associated 5QI value (e.g., a dedicated q-RxLevMin+5QI=x, in which x is a numerical value that maps or correlates to the application service (e.g., VoNR or the other type of application service)).

According to an exemplary embodiment, the minimum receive level value may be transmitted to an end device via a control plane message. According to an exemplary implementation, the control plane message may be a SIB message.

According to an exemplary embodiment, the minimum receive level value for reestablishment may be distinctive or different from a minimum receive level value for radio non-reestablishment (e.g., initial attachment). According to an exemplary implementation, the minimum receive level value for reestablishment may be a lower value relative to the minimum receive level value for radio non-reestablishment. According to some exemplary embodiments, the control plane message may include multiple minimum receive level values in which there is a minimum receive level value pertaining to reestablishment and a minimum receive level value pertaining to non-reestablishment, as described herein.

According to an exemplary embodiment, the reestablishment connectivity service may include artificial intelligence and/or machine learning (AI/ML) logic. For example, the AI/ML logic may, in whole or in part, calculate the minimum receive level value for reestablishment. According to an exemplary embodiment, the AI/ML logic may calculate the minimum receive level value based on end device reporting information, such as measurement reporting and various parameters and associated values, such as channel state information (CSI) (e.g., channel quality indicator (CQI), rank indicator (RI), timing advance (TA), precoding matrix indicator (PMI), etc.), etc.). The AI/ML logic may calculate the minimum receive level value for a cell in view of context information (e.g., day, time, cell coverage area, weather condition, etc.). According to an exemplary embodiment, the AI/ML may learn and predict the day, time, and cell to configure the minimum receive level value for reestablishment.

According to various exemplary embodiments, the AI/ML logic may be implemented at an access device, at a core device, an external device, or a combination or sub-combination of such devices, as described herein.

In view of the foregoing, the reestablishment connectivity service may address the disadvantages of having a single minimum receive level value (e.g., q-RxLevMin, etc.) for both reestablishment and non-reestablishment-related radio connectivity for an end device. The reestablishment connectivity service may improve the success of regaining end device connectivity when a reestablishment procedure is invoked, improve application service access and session maintenance, preserve network presence for the end device, optimize network resource utilization, and so forth.

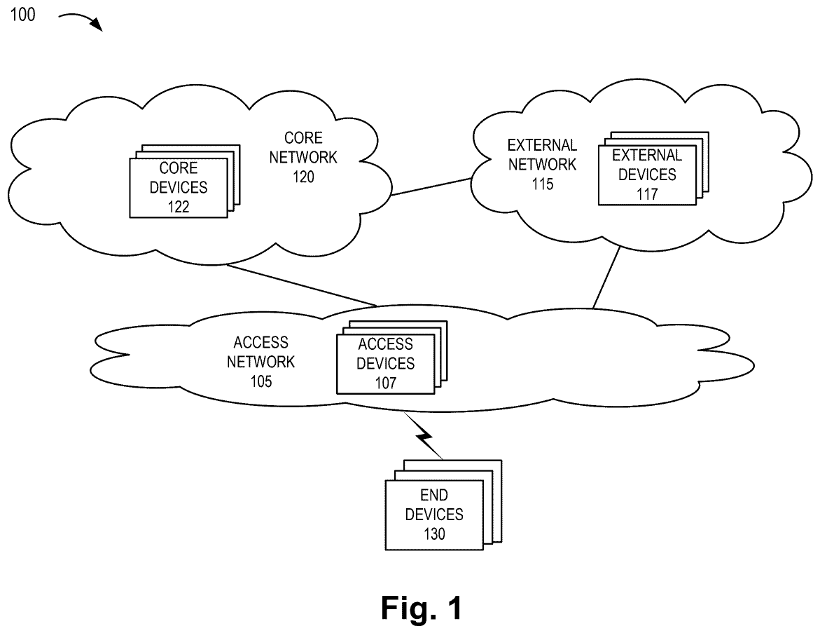

FIG. 1 is a diagram illustrating an exemplary environment 100 in which an exemplary embodiment of reestablishment connectivity service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), an optical network, a wired network, etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), virtual, logical, network slice, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communication connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the reestablishment connectivity service may use at least one of these planes. According to various exemplary implementations, the interface of the network device may be a service-based interface, a reference point-based interface, an Open Radio Access Network (O-RAN) interface, a 5G interface, another generation of interface (e.g., 5G Advanced, 6G, 7G, 4G, etc.), or some other type of network interface (e.g., proprietary, etc.).

Access network 105 may include one or multiple networks of one or multiple types and technologies. For example, access network 105 may be implemented to include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN (Long Term Evolution (LTE) Advanced, LTE Advanced Pro), etc.). Access network 105 may communicate with and/or include other types of access networks, such as, for example, a Wi-Fi® network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (COMP), various duplex schemes (e.g., frequency division duplex (FDD), time division duplex (TDD), half-duplex FDD (H-FDD), etc.), and/or another type of connectivity service (e.g., NSA NR, SA NR, etc.). Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station (BS), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 5G advanced wireless station, a 6G wireless station, a 7G wireless station, or another generation of wireless station), another type of wireless node (e.g., a WiFi/Wi-Fi® device, a hotspot device, an ultra-wideband (UWB)-enabled device, etc.) that provides a wireless access service, or another type of network device that provides a transport service (e.g., routing and forwarding), such as a router, a switch, or another type of layer 3 (e.g., network layer of the Open Systems Interconnection (OSI) model) network device.

According to some exemplary implementations, access device 107 may include a combined functionality of multiple RATs (e.g., 4G and 5G functionality, 5G and 5G Advanced functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to various exemplary implementations, access device 107 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 107 may provide a wireless access service at a cell, a sector, a sub-sector/zone, carrier, and/or other configurable level. For example, the sub-sector/zone level may include multiple divisions of a geographic area of a sector relative to access device 107. By way of further example, the sector may be divided based on proximity to the antenna of access device 107 (e.g., near, mid, far) and/or another criterion. According to another example, radio coverage of a location may be divided based on a Military Grid Reference System (MGRS) or another type of grid system to produce geo-bins. The size and/or shape of each geo-bin may be configurable. The size and/or the shape of a geo-bin may depend on the types of access device 107 (e.g., small cell device versus gNB, etc.), attributes of access device 107 (e.g., antenna configuration, radio frequency band of beam, etc.), and/or other factors (e.g., terrain of the radio covered locale).

According to an exemplary embodiment, at least some of access devices 107 may include logic of the reestablishment connectivity service, as described herein. According to an exemplary embodiment, access device 107 may include AI/ML logic that generates the minimum receive level value for reestablishment, as described herein. For example, according to an exemplary embodiment, a RIC or similar type of wireless station controller device may include the AI/ML logic of the reestablishment connectivity service. According to such an embodiment, the RIC may generate and provision or provide another access device 107 (e.g., wireless station, such as a gNB, a DU, a CU, or the like) with a minimum receive level value, as described herein. According to another example, the AI/ML logic may be implemented in the wireless station (e.g., the gNB, the DU, the CU, or the like). According to still other exemplary embodiments, the AI/ML logic may be implemented by external device 117. For example, an edge server, a cloud server, a virtualized server, or the like that may generate and provision or provide access device 107 with the minimum receive level value, as described herein. According to some exemplary embodiments, the AI/ML logic may generate the minimum receive level value that may be application, category of an application specific, traffic and/or QoS specific. For example, the minimum receive level value may correlate to a 5QI value, an individual or category of an application service, a traffic characteristic, and/or the like.

According to an exemplary embodiment, access device 107 may transmit the minimum receive level value (for reestablishment) to end device 130 via a control plane message. For example, access device 107 may broadcast a SIB message, which includes the minimum receive level value (for reestablishment), to end device 130. According to some exemplary embodiments, the control plane message may also indicate a correlated application service, category of an application service, a traffic type, a QoS value (e.g., 5QI value or the like), or a combination of two or more of these aspects. According to an exemplary embodiment, the control plane message may include multiple minimum receive level values (e.g., for reestablishment, for non-reestablishment, etc.).

External network 115 may include one or multiple networks of one or multiple types and technologies that provides an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an IMS network, a Rich Communication Service (RCS) network, a software defined (SD) network, a virtual network, a packet-switched network, a data center, or other type of network that may provide access to and may host an end device application service.

Depending on the implementation, external network 115 may include various network devices such as external devices 117. For example, external devices 117 may include virtual network devices (e.g., virtualized network functions (VNFs), servers, host devices, containers, hypervisors, virtual machines (VMs), network function virtualization infrastructure (NFVI), and/or other types of virtualization elements, layers, hardware resources, operating systems, engines, etc.) that may be associated with application services for use by end devices (not illustrated). By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). External network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IOT) services (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, conferencing, instant messaging), video streaming, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

According to some exemplary embodiments, external device 117 may include the AI/ML logic of the reestablishment connectivity service, as described herein. For example, an AI/ML device may obtain RAN information, calculate the minimum receive level value or the minimum receive level value and correlated data (e.g., 5QI, application identifier, etc.), and provide or provision access device 107 with the calculated minimum receive level value or minimum receive level value and correlated data, as described herein.

Core network 120 may include one or multiple networks of one or multiple network types and technologies. Core network 120 may include a complementary network of access network 105. For example, core network 120 may be implemented to include a 5G core network, an EPC of an LTE network, a future generation core network (e.g., a 5G Advanced, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a network slice selection function (NSSF), a network repository function (NRF), a policy control function (PCF), a network data analytics function (NWDAF), a network exposure function (NEF), a service capability exposure function (SCEF), a lifecycle management (LCM) device, an application function (AF), a mobility management entity (MME), a packet gateway (PGW), an enhanced packet data gateway (ePDG), a serving gateway (SGW), an application function (AF), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5G Advanced, 5G and 6G, etc.), such as an SMF with PGW control plane functionality (e.g., SMF+PGW−C), a UPF with PGW user plane functionality (e.g., UPF+PGW−U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a phablet, a wearable device (e.g., a watch, glasses, etc.), a computer, a gaming device, a music device, an IoT device, a drone, a smart device, a television, a set top box, a media player or streaming device, a telematics device, or another type of wireless device (e.g., another type of UE). End device 130 may be configured to execute various types of software (e.g., applications, programs, etc.). The number and the types of software may vary among end devices 130. End devices 130 may include “edge-aware” and/or “edge-unaware” application service clients. For purposes of description, end device 130 is not considered a network device.

According to an exemplary embodiment, end device 130 may include logic of the reestablishment connectivity service, as described herein. For example, the reestablishment connectivity service may be provided by a smartphone, a tablet, a computer, a user-operated device, or a non-user operated device (e.g., an IoT device, etc.). According to an exemplary embodiment, end device 130 may identify and/or select the minimum receive level value, which is dedicated for reestablishment, for use in executing a reestablishment procedure. According to an exemplary embodiment, end device 130 may select the minimum receive level value based on information associated with the application service session (e.g., individual application service, category of the application service, a 5QI value, or the like) that correlates to the minimum receive level value for reestablishment. End device 130 may execute a cell reselection procedure to reestablish radio connectivity with a cell (e.g., a source cell, a target cell, etc.) based on the minimum receive level value for reestablishment, as described herein.

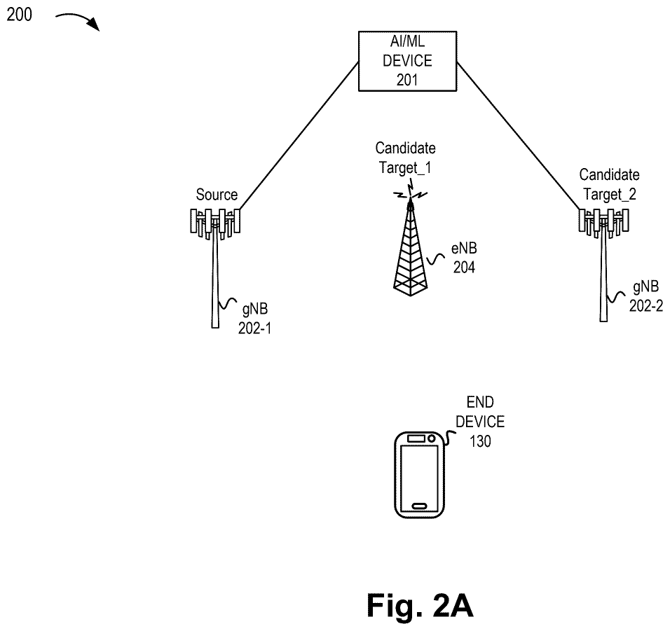

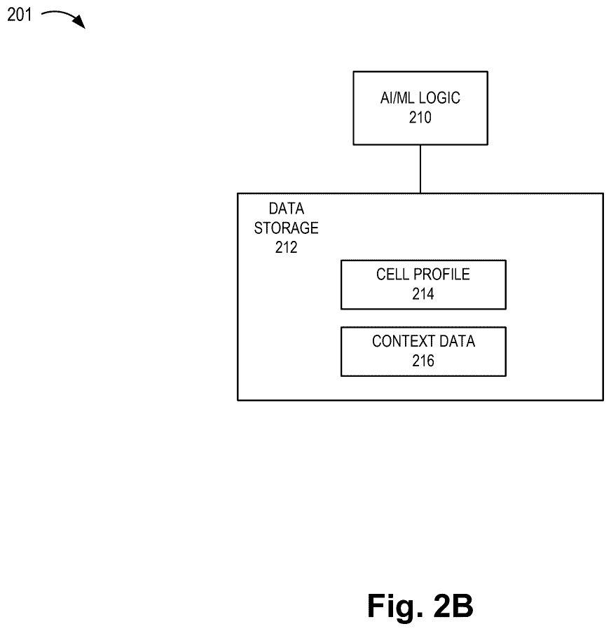

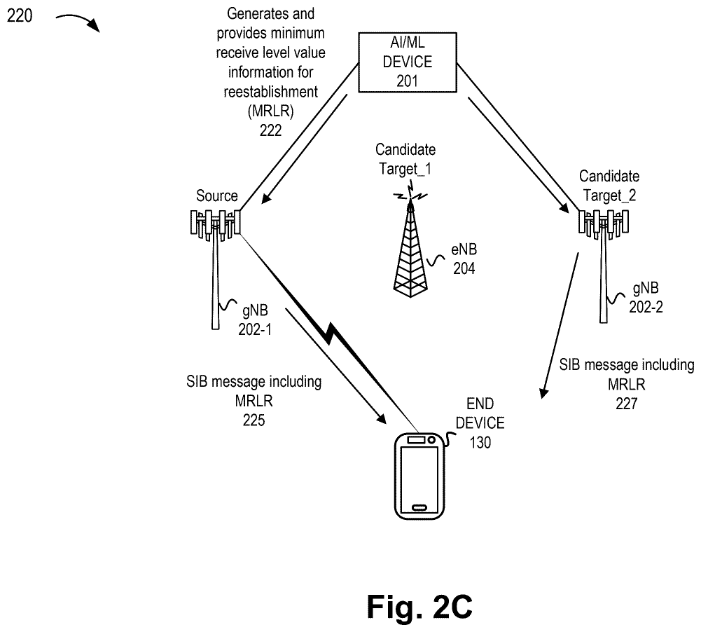

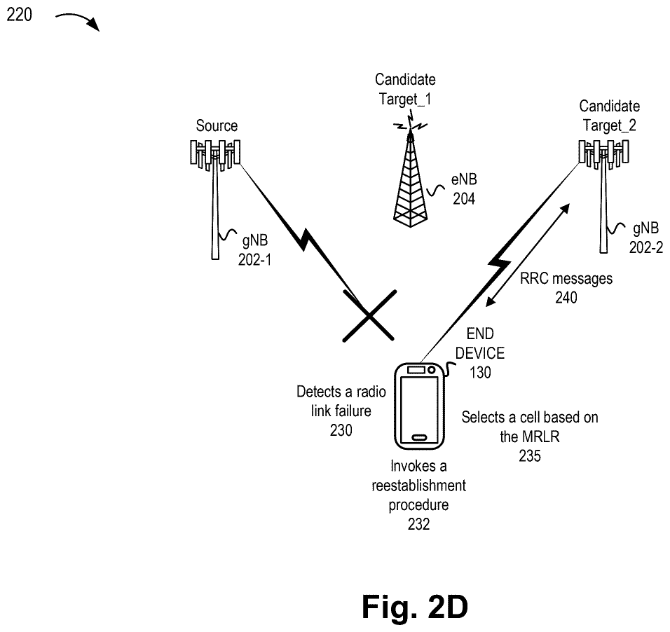

FIG. 2A is a diagram illustrating an exemplary environment 200 in which an exemplary embodiment of the reestablishment connectivity service may be implemented. As illustrated, according to this example, environment 200 may include end device 130, an AI/ML device 201, and access devices 107 (e.g., a gNB 202-1, a gNB 202-2, and an eNB 204). As described in relation to FIG. 1, according to other exemplary embodiments, the environment may include another type of access device 107 (e.g., a CU, a DU, an eLTE eNB, etc.,) not specifically illustrated and described in FIG. 2. Additionally, or alternatively, according to other embodiments, AI/ML device 201 may be implemented in gNB 202-1, gNB 202-2, or eNB 204, or combination of two or more of these access devices 107.

According to this exemplary environment 200, AI/ML device 201 may be implemented by a wireless station controller (e.g., a RIC, a BSC, a non-standard or proprietary access device 107, or the like), external device 117 (e.g., an edge server device, a cloud server device, an application server, an AF, or the like), or another network device of a network (e.g., access network 105, core network 120, etc.), such as a network management device, a network performance device, an NWDAF, and so forth. AI/ML device 201 is described further in relation to FIG. 2B.

FIG. 2B is a diagram illustrating exemplary functional components of access device 107 that includes AI/ML logic of the reestablishment connectivity service. As illustrated, access device 107 may include AI/ML logic 210 and data storage 212. According to other exemplary embodiments, AI/ML device 201 may include additional, fewer, and/or different functional components pertaining to an exemplary embodiment of the reestablishment connectivity service. Additionally, or alternatively, one or more functional components may be combined and/or one or more operations, functions, and/or subservices may be divided into one or more dedicated functional components not illustrated.

AI/ML logic 210 may include an AI/ML model that may provide or support the reestablishment connectivity service, as described herein. According to an exemplary embodiment, the AI/ML model may be implemented as a neural network model (NNM), a Generalized Linear Model (GLM), a Decision Tree, or another type of learning-based algorithm. According to an exemplary embodiment, the reestablishment connectivity service may use an optimization algorithm, such as a reinforcement learning algorithm or another type of learning algorithm (e.g., supervised learning, etc.). The goal of the optimization may be configurable. For example, the optimization may relate to minimization of radio connection reestablishment failures associated with a cell, frequency band, carrier frequency, or the like. According to other examples, the optimization may relate to reestablishment of an application service session associated with an application service or a category of an application service and the cell, frequency band, carrier frequency, or the like. According to yet other examples, the optimization may relate to QoS metric (e.g., throughput, bandwidth, delay, 5QI, etc.) and/or service level agreement (SLA) adherence regarding an application service/traffic associated with end device 130 and the cell, frequency band, carrier frequency, or the like. According to various exemplary embodiments, the optimization goal may include one or multiple optimizations.

According to an exemplary embodiment, AI/ML logic 210 may calculate the minimum receive level value for a cell in view of cell profile data 214 and context data 216. AI/ML logic 210 may learn and predict the day, time, and cell to configure the minimum receive level value for reestablishment. According to an exemplary embodiment, AI/ML logic 210 may calculate the minimum receive level value for a subset of cells of a given radio coverage area. For example, AI/ML logic 210 may be preconfigured to calculate the minimum receive level values for cells that support an application service, a 5QI value, and the like, as described herein. As an example, AI/ML logic 210 may select and provide or provision access devices 107 with minimum receive level cell information that pertain to a frequency band of relevance. According to another example, AI/ML logic 210 may select and provide or provision access devices 107 with minimum receive level cell information that pertain to a frequency band and a 5QI value or the like, as described herein.

Data storage 212 may include a storage device that stores data used by AI/ML logic 210. For example, data storage 212 may store cell profile data 214 and context data 216. According to various exemplary embodiments, instances of cell profile data 214 and context data 216 may be obtained from access device 107 (e.g., gNB 202-1, gNB 202-2), a third party device (not illustrated), a network management device, or another type of network device of a network (e.g., core device 122, external device 117, etc.) that may have information of relevance for calculating minimum receive level values. According to an exemplary embodiment, AI/ML logic 210 may output data and store such data in data storage 212. According to various exemplary embodiments, data storage 212 may store historical data, current data, and prospective data regarding certain types of data, as described herein. As an example, cell profile data 214 may include historical, current, and prospective data, as described herein.

Cell profile data 214 may include data regarding cells, such as radio frequency bands, carrier frequencies, channels, or the like. Cell profile data 214 may include measurement report data from end devices 130 and other types of parameters and values, as described herein. For example, cell profile data 214 may include CSI (e.g., CQI, RI, TA, PMI, etc.). Cell profile data 214 may include success and failure rates regarding reestablishment associated with a cell by end device 130.

Context data 216 may include data that may influence calculation of minimum receive level values. For example, context data 216 may include data indicating network performance issues or degradation regarding a coverage service area, access device 107, a cell of access device 107, or the like. Context data 216 may include weather data (e.g., temperature, precipitation, storm, wind speed, etc.), network alarm data indicating an unplanned outage (e.g., power, network device, etc.), terrain data of a radio coverage area associated with a cell (e.g., urban, suburban, rural, buildings, vegetation, foliage, highway, or other types of land cover features or characteristics, etc.), or the like.

According to other exemplary embodiments, data storage 212 may store fewer, additional, and/or different instances of data, which may be of relevance for calculating minimum receive level values, as described herein. For example, AI/ML logic 210 may have access to (or is stored by data storage 212) network topology information. The network topology information may indicate the type and placement of access devices 107. The network topology information may include access device identifiers. The network topology information may include information relating to components of access devices 107, such as antennas (e.g., height, number, type, gain, transmit loss, receive loss, receive signal, fade margin (e.g., thermal, effective, etc.), and other characteristics (e.g., carrier frequencies, frequency bands, cells, radio access technology (RAT), cell coverage, sector coverage, sub-sector/zone coverage)) and configurations (e.g., CA, DC, CoMP, etc.). The network topology information may include map information, terrain (e.g., buildings, vegetation, roads, etc.) associated with a cell, a sector, a sub-sector of access device 107, and so forth. AI/ML logic 210 may select access device 107 and cell for calculating the minimum receive level value based on the network topology information in combination with cell profile data 214 and context data 216, for example.

According to an exemplary embodiment, AI/ML logic 210 may or may not adjust minimum receive level cell information based on a re-evaluation or analysis of cell profile data 214, context data 216, network topology information, and like. In this way, AI/ML logic 210 may learn and optimize minimum receive level values for reestablishment based on feedback information associated with historical values.

FIGS. 2C and 2D are diagrams illustrating an exemplary process 220 of an exemplary embodiment of the reestablishment connectivity service according to an exemplary scenario. As illustrated, process 220 may be implemented in environment 200 that includes a device that provides an exemplary embodiment of the reestablishment connectivity service.

Referring to FIG. 2C, assume that end device 130 has established a radio connection with gNB 202-1. According to various exemplary scenarios, end device 130 may or may not have an active application service session (e.g., with external device 117, not illustrated). By way of further example, end device 130 may or may not be participating in a voice call or another type of application service session.

According to an exemplary embodiment, AI/ML device 201 may obtain data, such as cell profile data 214 and context data 216. According to some exemplary embodiments, AI/ML device 201 may obtain or have access to network topology information associated with access network 105 or a portion of access network 105. According to an exemplary embodiment, AI/ML 201 may be configured to select cells to which the reestablishment connectivity service pertains. For example, a user, such as a network administrator or the like, may configure a frequency band, a carrier frequency, or the like that is subject to the reestablishment connectivity service. According to another exemplary embodiment, the user may configure a 5QI value, an application identifier, a traffic characteristic, or the like that the reestablishment connectivity service is subject to and AI/ML device 201 may select which cells may be provided or provisioned with minimum receive level cell information for reestablishment, as described herein.

According to an exemplary step of process 220, AI/ML device 201 may generate and provide minimum receive level cell information for reestablishment 222 to gNB 202-1 and gNB 202-2. AI/ML device 201 may generate the minimum receive level cell information based on cell profile data 214 and potentially other types of data, configuration data, and a model, as described herein.

According to some exemplary embodiments, the minimum receive level cell information may include a minimum receive level value (e.g., a q-RxLevMin value or a q-RxLevMinSUL value) in combination with an offset value (e.g., a q-RxLevMinoffsetcell value or a q-RxLevMinoffsetcellSUL value) and a frequency band, a cell, a carrier frequency, or the like, as described herein. According to some exemplary embodiments, the minimum receive level cell information may also include data indicating that the minimum receive level value pertains to reestablishment. According to some exemplary embodiments, the minimum receive level cell information may include the minimum receive level value and a frequency band, a cell, a carrier frequency, or the like and/or other correlated information. For example, the other correlated information may include a 5QI value, an application service identifier, a category of an application service, or a traffic characteristic, or a combination or sub-combination of these instances of data, as described herein. According to various exemplary scenarios, the minimum receive level cell information may be the same or different between gNB 202-1 and gNB 202-2.

As further illustrated, according to an exemplary step of process 220, gNB 202-1 and gNB 202-2 may each transmit a SIB message that includes the minimum receive level information for reestablishment. For example, gNB 202-1 may broadcast a SIB message 225 including the minimum receive level cell information, and gNB 202-2 may broadcast a SIB message 227 including the minimum receive level cell information. Additionally, as previously described, SIB message 225 and/or SIB message 227 may further include a minimum receive level value for non-reestablishment. According to some exemplary embodiments, SIB message 225 and/or SIB message 227 may further include data indicating that a minimum receive level value pertains to reestablishment or non-reestablishment, as described herein.

Referring to FIG. 2D, end device 130 may detect a radio link failure 230. In response, end device 130 may invoke a reestablishment procedure 232. For example, end device 130 may perform cell measurement and apply the minimum receive level cell information for cell reselection based on SIB messaging. Depending on the mobility of end device 130, among other factors, end device 130 may read and apply the minimum receive level cell information from gNB 202-1 and/or gNB 202-2, for example. According to some exemplary embodiments where end device 130 was in an active application service session, end device 130 may determine whether the minimum receive level cell information is relevant or matches aspects of the application service session based on the correlated data (e.g., 5QI value, application service identifier, category of the application service, traffic characteristic value(s), frequency band, data indicating reestablishment or non-reestablishment, etc.).

According to this exemplary scenario, end device 130 may select 235 a cell of gNB 202-2 based on the minimum receive level cell information. As a part of the reestablishment procedure, end device 130 and gNB 202-2 may exchange RRC messages 240. According to an exemplary scenario in which end device 130 was participating in an active application service session, end device 130 may continue with the application service session via gNB 202-2. Otherwise, according to another exemplary scenario, end device 130 may reestablish a radio connection with access network 105 via gNB 202-2. According to other exemplary scenarios, end device 130 may select a cell of gNB 202-2 and reestablish a radio connection.

FIGS. 2C and 2D are diagrams illustrating an exemplary process 220 of an exemplary embodiment of the reestablishment connectivity service. According to other exemplary embodiments and scenarios, process 220 may include additional operations, fewer operations, and/or different operations.

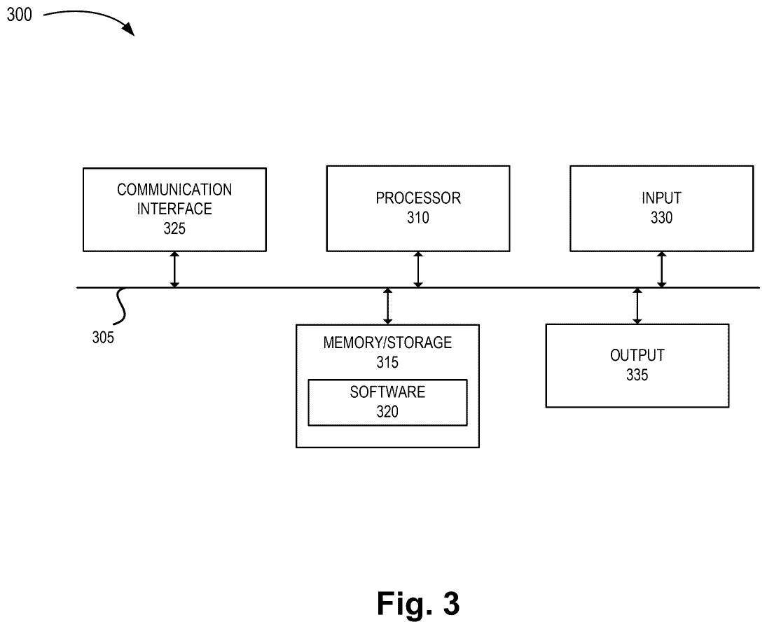

FIG. 3 is a diagram illustrating exemplary components of a device 300 that may be included in one or more of the devices described herein. For example, device 300 may correspond to access device 107, external device 117, core device 122, end device 130, AI/ML device 201, gNB 202, eNB 204, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, a solid state drive, mass storage, off-line storage, cloud storage, or some other type of storing medium. Memory/storage 315 may store data, software, and/or instructions related to the operation of device 300.

Software 320 includes an application or a program that provides a function and/or a process. As an example, with reference to AI/ML device 201 or access device 107, software 320 may include an application that, when executed by processor 310, provides a function and/or a process of reestablishment connectivity service, as described herein. Additionally, with reference to external device 117, software 320 may include an application that, when executed by processor 310, provides a function and/or a process of reestablishment connectivity service, as described herein. Software 320 may also include firmware, middleware, microcode, hardware description language (HDL), and/or other form of instruction. Software 320 may also be virtualized. Software 320 may further include an operating system (OS) (e.g., Windows, Linux, Android, proprietary, etc.).

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, a joystick, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life cycle (e.g., refreshed, paused, suspended, rebooting, or another type of state or status), using well-known virtualization technologies. For example, access device 107, core device 122, external device 117, and/or another type of network device or end device 130, as described herein, may be a virtualized device.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions that are stored by memory/storage 315 cause processor 310 to perform a function or a process described herein. Alternatively, for example, according to other implementations, device 300 performs a function or a process described herein based on the execution of hardware (processor 310, etc.).

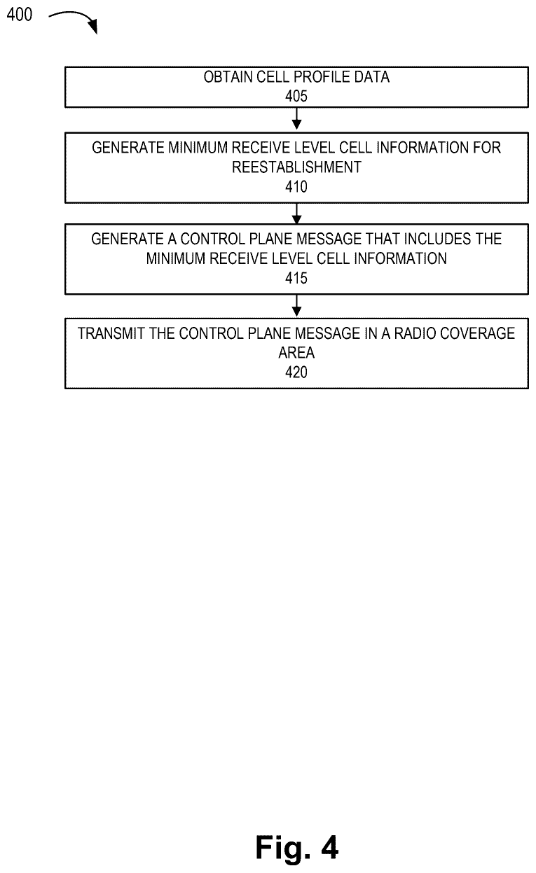

FIG. 4 is a flow diagram illustrating an exemplary process 400 of an exemplary embodiment of the reestablishment connectivity service. According to an exemplary embodiment, access device 107 or external device 117, as described herein, may perform a step of process 400. According to an exemplary implementation, processor 310 executes software 320 to perform a step of process 400, as described herein. Alternatively, a step may be performed by execution of only hardware. For purposes of description, process 400 is described as being performed by access device 107.

In block 405, access device 107 may obtain cell profile data. For example, access device 107 may receive cell profile data from end devices 130 and potentially other network devices, as described herein. Access device 107 may also obtain other types of data, such as context data, network topology information, and the like, as described herein. AI/ML logic 210 may be configured with a parameters and a value, such as a frequency band, a 5QI value, etc., to which the reestablishment connectivity service pertains, as described herein.

In block 410, access device 107 may generate minimum receive level cell information for reestablishment. For example, access device 107 may generate the minimum receive level cell information based on the cell profile data. Access device 107 may generate the minimum receive level cell information based on other information, such as context data, network topology information, and the like. The minimum receive level cell information may include a minimum receive level value (e.g., a q-RxLevMin value, a q-RxLevMinSUL value, an offset value). The minimum receive level cell information may include correlated data, such as a frequency band, a carrier frequency, or the like. The correlated data may further include one or more of a 5QI value, an application identifier, a category of an application service, or a traffic characteristic value. According to some exemplary embodiments, the correlated data may also include data indicating that the minimum receive level value pertains to reestablishment.

In block 415, access device 107 may generate a control plane message that includes the minimum receive level cell information. For example, access device 107 may generate a SIB message. The SIB message includes the minimum receive level cell information.

In block 420, access device 107 may transmit the control plane message in a radio coverage area. For example, access device 107 may transmit the SIB message to end devices 130 located in the radio coverage area of relevance to the reestablishment connectivity service.

FIG. 4 illustrates an exemplary process of the reestablishment connectivity service, according to other exemplary embodiments, the reestablishment connectivity service may perform additional operations, fewer operations, and/or different operations than those illustrated and described. For example, process 400 may include a step that provisions or provides the minimum receive level cell information with access device 107. By way of further example, when AI/ML device 201 is implemented in a wireless station controller (e.g., a RIC device, a BSC or the like), AI/ML device 201 may provision or provide the generated minimum receive level cell information (in block 410) to a wireless station, such as an integrated RAN or access device 107 (e.g., gNB, eNB, etc.) or a split RAN or access device 107 (e.g., a CU, a DU+CU, etc.).

According to another exemplary embodiment, process 400 may include a step that reestablishes a radio connection with end device 130. For example, access device 107 may transmit the control plane message, and subsequently perform a reestablishment procedure with at least one of end devices 130.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIG. 4, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
obtaining, by a network device, cell profile data pertaining to a cell of a radio access network;
generating, by the network device based on the cell profile data, minimum receive level cell information that includes a first minimum receive level value used only for radio connection reestablishment by an end device;
generating, by the network device, a control plane message that includes the first minimum receive level cell information; and
transmitting, by the network device, the control plane message.

2. The method of claim 1, wherein the first minimum receive level value includes q-RxLevMin value or a q-RxLevMinSUL value.

3. The method of claim 1, wherein the cell profile data includes measurement report data from end devices.

4. The method of claim 1, wherein the control plane message includes a second minimum receive level value used only for radio connection non-reestablishment by the end device, and wherein the second minimum receive level value differs from the first minimum receive level value.

5. The method of claim 1, wherein the first minimum receive level value includes an offset.

6. The method of claim 1, wherein the first minimum receive level cell information includes at least one of a Fifth Generation Quality of Service Identifier (5QI) value, an application service identifier, a category of an application service, or data indicating reestablishment.

7. The method of claim 1, further comprising:
establishing, by the network device, a first radio connection with the end device via the cell;
losing, by the network device, the first radio connection; and
reestablishing, by the network device after the transmitting, a second radio connection with the end device via the cell.

8. The method of claim 1, wherein the network device is an integrated or a split radio access network device of the radio access network.

9. A network device comprising:
a processor that is configured to:
obtain cell profile data pertaining to a cell of a radio access network;
generate, based on the cell profile data, minimum receive level cell information that includes a first minimum receive level value used only for radio connection reestablishment by an end device;
generate a control plane message that includes the first minimum receive level cell information; and
transmit the control plane message.

10. The network device of claim 9, wherein the first minimum receive level value includes q-RxLevMin value or a q-RxLevMinSUL value.

11. The network device of claim 9, wherein the cell profile data includes measurement report data from end devices.

12. The network device of claim 9, wherein the control plane message includes a second minimum receive level value used only for radio connection non-reestablishment by the end device, and wherein the second minimum receive level value differs from the first minimum receive level value.

13. The network device of claim 9, wherein the first minimum receive level value includes an offset value.

14. The network device of claim 9, wherein the first minimum receive level cell information includes at least one of a Fifth Generation Quality of Service Identifier (5QI) value, an application service identifier, a category of an application service, or data indicating reestablishment.

15. The network device of claim 9, wherein the processor is further configured to:
establish a first radio connection with the end device via the cell;
lose the first radio connection; and
reestablish, after the transmission of the control plane message, a second radio connection with the end device via the cell.

16. The network device of claim 9, wherein the network device is an integrated or a split radio access network device of the radio access network.

17. A non-transitory computer-readable storage medium storing instructions executable by a processor of a device, wherein the instructions are configured to:
obtain cell profile data pertaining to a cell of a radio access network;
generate, based on the cell profile data, minimum receive level cell information that includes a first minimum receive level value used only for radio connection reestablishment by an end device;
generate a control plane message that includes the first minimum receive level cell information; and
transmit the control plane message.

18. The non-transitory computer-readable storage medium of claim 17, wherein the first minimum receive level value includes q-RxLevMin value or a q-RxLevMinSUL value.

19. The non-transitory computer-readable storage medium of claim 17, wherein the cell profile data includes measurement report data from end devices.

20. The non-transitory computer-readable storage medium of claim 17, wherein the first minimum receive level cell information includes at least one of a Fifth Generation Quality of Service Identifier (5QI) value, an application service identifier, a category of an application service, or data indicating reestablishment.
